(19) United States
(12) Patent Application Publication
(10) Pub. No.: US 2012/0072522 A1
(43) Pub. Date: Mar. 22, 2012

(54) RADIO COMMUNICATION SYSTEM

(75) Inventor: Hiroyuki Sekino, Tokyo (JP)

(73) Assignee: YAMATAKE CORPORATION, Tokyo (JP)

(21) Appl. No.: 13/234,303

(22) Filed: Sep. 16, 2011

(30) Foreign Application Priority Data
Sep. 22, 2010 (JP) 2010-211834

(51) Int. Cl. G06F 15/16

(52) U.S. Cl. 709/208

(57) ABSTRACT

Based on slave information from a master device (a maximum number of connectable slaves Nmax and an address reporting period) and on a device number #n that is set locally, slave devices calculate address information reporting timing and, after a delay, report the local address information (a logical address and a communication address) to the master device with each period. Each time address information is received, the master device stores a combination of the logical address and the communication address, and if, at the time of this storing, a logical address matching the received logical address has already been stored, checks the communication address that is stored in combination with that logical address, and if the received communication address does not match, determines that the received logical address is redundant.

### CROSS REFERENCE TO RELATED APPLICATIONS

The present application claims priority under 35 U.S.C. §119 to Japanese Patent Application No. 2010-211834, filed Sep. 22, 2010, which is incorporated herein by reference.

### FIELD OF TECHNOLOGY

The present invention relates to a radio communication system structured from a master device and a plurality of slave devices.

### BACKGROUND OF THE INVENTION

Recent years have seen increasing use of systems that use radio communication to perform environmental measurements, monitoring, control, and the like. In radio communication systems that perform environmental measurements, monitoring, control, and like, often the areas involved are relatively large, and often there are many obstructions to radio communication within those areas. In such cases it is beneficial to use a radio communication network able to perform communication relayed by other devices to enable coverage within the area even when direct communication is not possible due to the environment, such as the installation locations of the receiving device and the transmitting device, the state of radio signals, and the like.

For this type of radio communication network, radio communication network that use the ZigBee™ protocol (such as in, for example, Japanese Unexamined Patent Application Publication 2006-5928 and Japanese Unexamined Patent Application Publication 2006-42370) and other mesh networks have been proposed. In this mesh network, bidirectional communication between a master device and a slave device is relayed by another slave device within a service area wherein direct communication is possible, and thus this is a technology wherein even if one communication route becomes unable to communicate due to multi-path phasing, the communication can be relayed by finding another communication route. Note multipath phasing is a phenomenon wherein the radio waves that are received are canceled out through phase differences that are produced between multiple communication radio signal reflection paths, preventing reception.

In this type of radio communication system having a master device and a plurality of slave devices, logical addresses, which are separate from the communication addresses that are assigned by the master device, are set for the slave devices, as a single system based on the system protocol. These logical addresses are established individually in accordance with the system structure, and normally are set manually. Because of this, sometimes redundant logical addresses are set for different slave devices. Desirable operation would not be possible if the system were to operate while still in a state wherein redundant logical addresses are set; hence it is necessary to detect redundancies.

Given this, as a conventional logical address redundancy detecting method, a method has been disclosed wherein a relay that relays packets in a packet communication-type network extracts and stores the logical address for each individual packet and detects redundancies between stored logical addresses and extracted logical addresses, providing notification to the network administration terminal if a redundancy is detected (See, for example, Japanese Unexamined Patent Application Publication H6-75900 (“JP '900”)).

However, when the logical address redundancy detecting method disclosed in JP '900, described above, is applied to a mesh network that uses the ZigBee protocol, there is the possibility that excessive communication traffic will be produced when a communication route is structured from the various relay stations (the master device or slave devices) when, for example, the power supplies are turned ON, preventing a relay from receiving a message, in which case the logical address redundancy will not be detected. Moreover, if there is no system by which to ensure that the relay receives all messages that exist within a network, through some method, it will not be possible to detect logical address redundancies for all of the devices that exist on the network.

The present invention was created in order to solve the problem as set forth above, and the object thereof is to provide a radio communication system wherein it is possible to detect with stability a logical address redundancy.

### SUMMARY OF THE INVENTION

The invention by which to achieve such an object is a radio communication system comprising first through Nth (N≧2) slave devices and a master device for receiving messages from these slave devices, wherein the master device includes slave information storing means for storing, as slave information, a maximum connectable number of slave devices and a reporting period for address information from slave devices; address information report requesting means for broadcasting, at at least the time of startup, the slave information to the first through Nth slave devices to request reporting of address information from the first through Nth slave devices; and logical address redundancy detecting means for detecting a redundancy in the logical addresses set in the first through Nth slave devices based on the logical addresses and communication addresses reported, as address information, from the first through Nth slave devices in response to the address information report request from the address information report requesting means. The first through Nth slave devices have device information storing means for storing, as device information, a device number that is determined sequentially with the maximum connectable number of slave devices as the maximum value, and a logical address and a communication address that are set as local address information; address information report timing calculating means for receiving the address information report request from the master device, and for calculating the timing for reporting the local address information based on the maximum connectable number of slave devices, which is received as slave information, the address information reporting period, and the device number that is stored as device information; and address information reporting means for reporting, to the master device, local address information that is stored as device information, with each address information reporting period, in accordance with the report timing calculated by the address information report timing calculating means.

In the present example, the master device, at at least the time of startup, broadcasts the slave information (the maximum connectable number of slaves Nmax and the reporting period T for the address information from the slave devices) to the first through Nth slave devices to request reporting of address information from the first through Nth slave devices. Upon receipt of the address information report request from the master device, the first through Nth slave devices calculate the timing ΔT for reporting the local address information based on the maximum connectable number of slave devices Nmax, the address information reporting period T, and the device number #n. For example, the timing for reporting the local address information is calculated as ΔT=#n*(T/Nmax). Additionally, in accordance with the calculated notification timing, the local address information (the logical address and communication address) is reported to the master device with each address information reporting period T.

The master device detects redundancies in the logical addresses set in the first through Nth slave devices based on the address information (the logical addresses and communication addresses) reported by the first through Nth slave devices. For example, each time address information is received from the first through Nth slave devices, stores a combination of the logical address and the communication address that have been sent as address information, and if, at the time of this storing, a logical address matching the received logical address has already been stored, checks the communication address that is stored in combination with that logical address, and if that stored communication address and the received communication address do not match, determines that the received logical address is redundant. In this case, the communication address that is stored in combination with the logical address that has been found to be redundant is overwritten to the received communication address for use in the next redundancy evaluation. Moreover, the logical address may be outputted to the outside if it is determined that the received logical address is redundant.

The present example makes it possible, on the master device side, to detect with stability redundancies in logical addresses, even when routes are restructured during operation, because the maximum connectable number of slave devices and the reporting period for address information from the slave devices is broadcasted, as slave information, by the master device to the first through Nth slave devices, where, in the first through Nth slave devices, the timing for reporting the local address information is calculated based on the maximum connectable number of slave devices, the reporting period for the address information, and the device numbers, and the local address information (the logical address and the communication address) are reported to the master device with each address information reporting period, in accordance with the calculated report timing, and where, in the master device, redundancies in the logical addresses set in the first through Nth slave devices are detected based on the logical addresses and communication addresses reported as address information from the first through Nth slave devices.

### BRIEF DESCRIPTION OF THE DRAWINGS

FIG. 1 is a sequence diagram for after the power supply has been turned ON in one form of embodiment of a radio communication system.

FIG. 2 is a flowchart illustrating a logical address redundancy detecting process of a master device in this radio communication system.

FIG. 3 is a sequence diagram (when a redundancy has occurred) for explaining a structural example of two slave devices in a specific example of logical address redundancy detection.

FIG. 4 is a sequence diagram (when the redundancy has been resolved) for explaining a structural example of two slave devices in a specific example of logical address redundancy detection.

FIG. 5 is a functional block diagram of the critical portions of a master device and a slave device in this radio communication system.

### DETAILED DESCRIPTION

Examples according to the present invention are explained below in detail, based on the drawings.

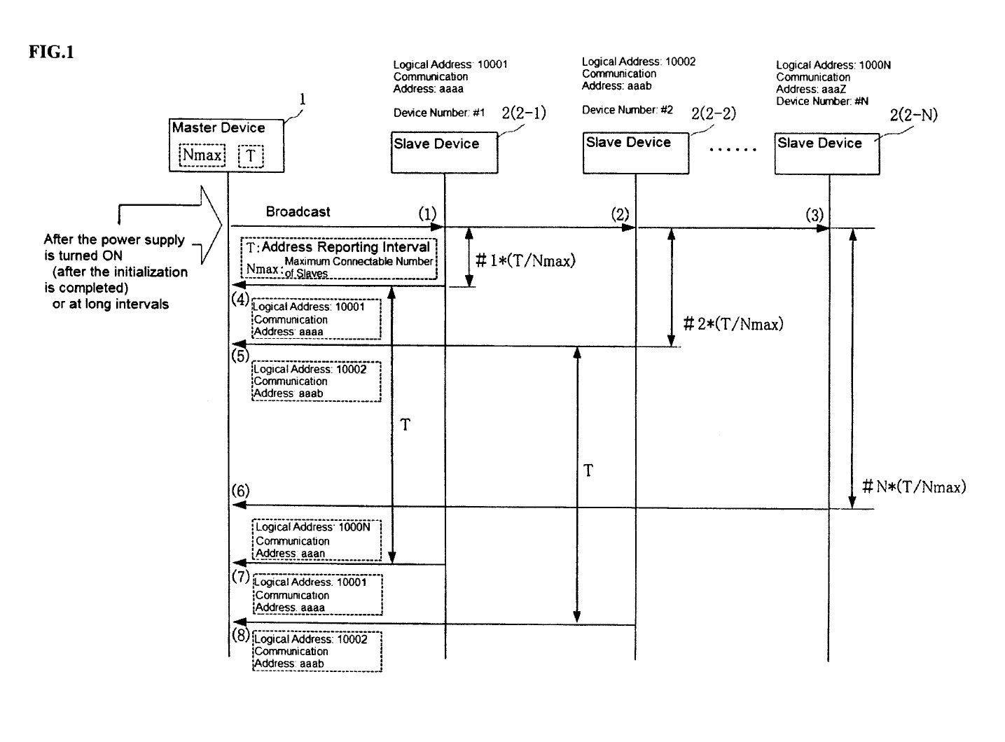

FIG. 1 is a sequence diagram for after the power supply has been turned ON in one example of a radio communication system. In the figures: 1 is a master device, and 2 (2-1 through 2-N) are slave devices.

In this radio communication system, a personal computer (hereinafter termed a “PC”), or the like is connected to the master device 1 and a maximum connectable number of slave devices (the maximum number of slaves that can be connected) Nmax and a communication period for address information from the slave devices (an address reporting period) T are set.

Moreover, a logical address, a communication address, and a device number are set in a slave device 2. The logical address is set manually through, for example, connecting the PC, and the communication address is assigned by a parent device (a master device or a slave device) when connecting to the network. Note that the device numbers are assigned sequentially by the master device 1, with the maximum connectable number of slave devices Nmax as the maximum value. Conversely, it may be a conversion of the logical address. For example, if the last two digits of the logical address are used as the device number, then if the logical address is “1002”, the device number would be #2.

In this example, “10001” is set as the logical address, “aaaa” is set as the communication address, and #1 is set as the device number in the slave device 2-1. Moreover, “10002” is set as the logical address, “aaab” is set as the communication address, and #2 is set as the device number in the slave device 2-2. The same is true thereafter, where each slave device 2 is assigned a logical address, a communication address, and a device number, where “1000N” is set as the logical address, “aaaN” is set as the communication address, and #N is set as the device number in the final slave device 2-N.

### Address Information Report Request From the Master Device

In this radio communication system, the master device 1, after the power supply has been turned ON (after initialization is complete) and at long intervals (for example, once each hour), using the maximum connectable number of slave devices Nmax and the address information communication period T from the slave devices as slave information, to broadcast, to the slave devices 2-1 through 2-N, a request for an address information report from the slave devices 2-1 through 2-N (FIG. 1: Arrows (1), (2), and (3)).

### Address Information Report From the Slave Devices (Smoothed)

Upon receipt of this address information report request from the master device 1, each of the slave devices 2-1 through 2-N, after a delay based on its own device number that has been set, informs the master device 1 of its own logical address and communication address with which it is set, as the address information, with each address information reporting period T that has been sent. In this example, the local device number is #n and a report timing for the address information is requested as ΔT=#n*(T/Nmax), and so, in accordance with this report timing ΔT, the local address information (the logical address+the communication address) is sent to the master device 1 with each address information reporting period T.

In this case, the slave device 2-1, after receiving an address information report request from the master device 1, requesting an address information report timing of ΔT=#1*(T/Nmax), reports, to the master device 1, the logical address “10001” and the communication address “aaaa”, which are set locally, doing so with each requested address information reporting period T, after a delay of ΔT=#1*(T/Nmax). (FIG. 1: Arrows (4) and (7)).

The slave device 2-2, after receiving an address information report request from the master device 1, requesting an address information report timing of ΔT=#2*(T/Nmax), reports, to the master device 1, the logical address “10002” and the communication address “aaab”, which are set locally, doing so with each requested address information reporting period T, after a delay of ΔT=#2*(T/Nmax). (FIG. 1: Arrows (5) and (8)).

The slave device 2-N, after receiving an address information report request from the master device 1, requesting an address information report timing of ΔT=#N*(T/Nmax), reports, to the master device 1, the logical address “1000N” and the communication address “aaaN”, which are set locally, doing so with each requested address information reporting period T, after a delay of ΔT=#N*(T/Nmax), (FIG. 1: Arrow (6)).

As a result, the address information reports from the slave devices 2-1 through 2-N are smoothed, making it possible for the logical address redundancy detection to be performed by the master device 1 without causing communication overhead.

### Logical Address Redundancy Detection at the Master Device

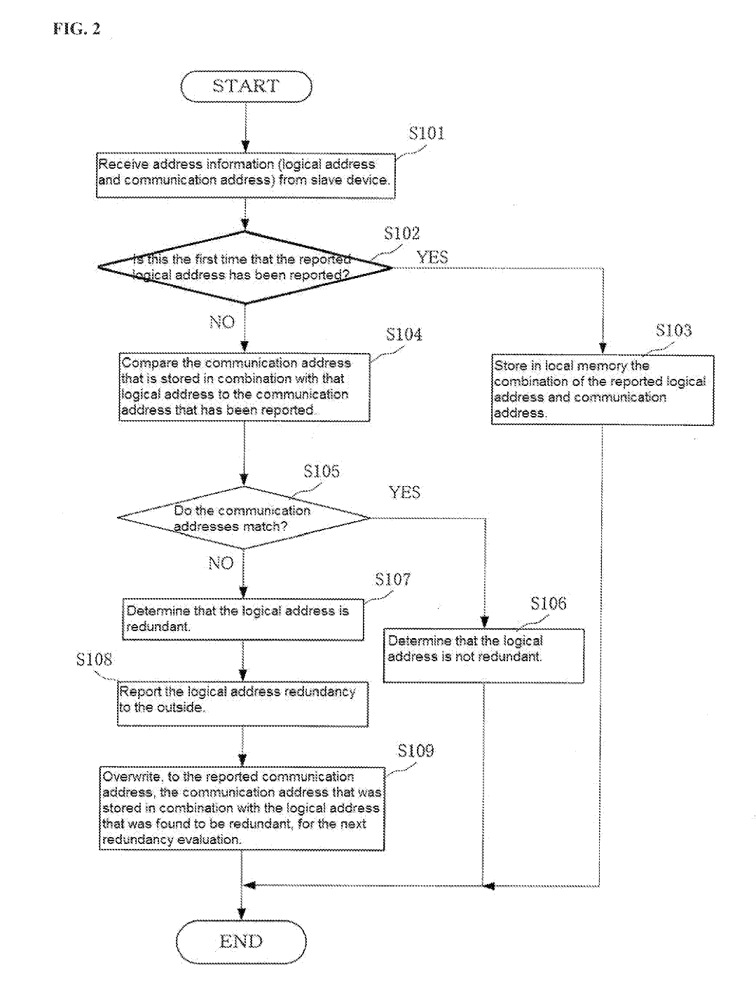

The master device 1 receives the address information (the logical address+communication address) sent from the slave device 2 (FIG. 2: Step S101). If, at this point, this is the first time that this reported logical address has been sent (Step S102: YES), then the combination of the reported logical address and communication address is stored in the local memory (Step S103).

In contrast, if a logical address matching the reported logical address is already stored in the local memory (Step S102: NO), then the communication address that is stored in combination with that logical address is compared to the reported communication address (Step S104), and if the two communication addresses match (Step S105: YES), then it is determined that the reported communication address is not redundant (Step S106).

In contrast, if the two communication addresses do not match (Step S105: NO), then it is determined that the reported logical address is redundant (Step S107), and a report is sent to the outside that a logical address redundancy has occurred (Step S108). In this event, the logical address that is redundant may be outputted to the outside, may be displayed on the screen of the connected PC, and so forth.

Additionally, the master device 1 may overwrite, to the reported communication address, the communication address that is stored in combination with the logical address that has been determined to be redundant, for use in the next redundancy evaluation (Step S109).

### Specific Example of Logical Address Redundancy Detection

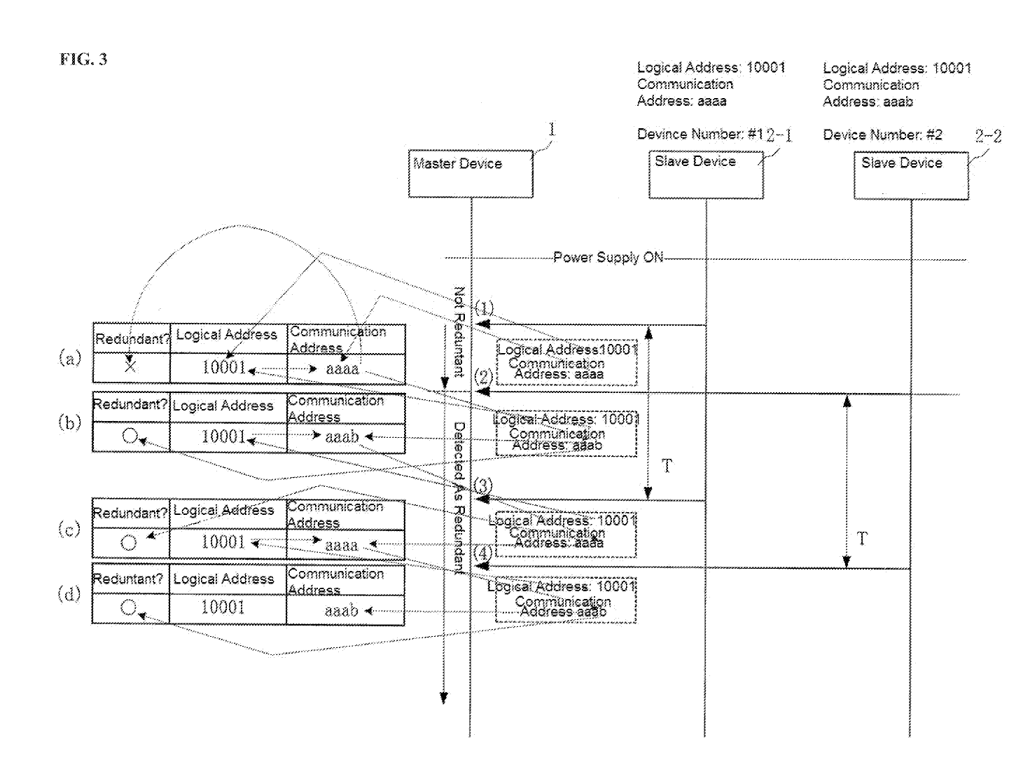

A specific example of logical address redundancy detection is explained here using a structural example of two slave devices. FIG. 3 shows a sequence diagram of this case. In this structural example, the power supplies for the master device 1 and the slave devices 2-1 and 2-2 are turned ON simultaneously in the same power supply system. Moreover, in this example the logical address of the slave device 2-2 is erroneously set to the logical address “10001”, which is the same as that of the slave device 2-1.

When the master device 1 receives the address information report from the slave device 2-1 for the first time after the power supply is turned ON (FIG. 3: Arrow (1)), it stores, in memory, the combination of the reported logical address “10001” and communication address “aaaa” as the address information from the slave device 2-1, (See FIG. 3 (a).) In this case, no logical address redundancy occurs.

Next, when the master device 1 receives the report of the address information from the slave device 2-2 (FIG. 3: Arrow (2)), it confirms that a logical address that matches the logical address of “10001” that was reported by the slave device 2-2 is already stored in the memory, and compares the communication address “aaaa” that is stored in combination with that logical address “10001” with the reported communication address “aaab”.

In this case, the communication address “aaaa” that has been stored and the reported communication address “aaab” do not match, and so it is determined that the reported logical address “10001” is redundant. Additionally, the communication address “aaaa” that is stored in combination with the logical address “10001 is overwritten to the reported communication address of “aaab”, for use in the next redundancy evaluation. (See FIG. 3 (b).)

Next, when the master device 1 receives the report of the address information from the slave device 2-1 (FIG. 3: Arrow (3)), it confirms that a logical address that matches the logical address of “10001” that was reported by the slave device 2-1 is already stored in the memory, and compares the communication address “aaab” that is stored in combination with that logical address “10001” with the reported communication address “aaaa”.

In this case, the communication address “aaab” that has been stored and the reported communication address “aaaa” do not match, and so it is determined that the reported logical address “10001” is redundant. Additionally, the communication address “aaab” that is stored in combination with the logical address “10001 is overwritten to the reported communication address of “aaaa”, for use in the next redundancy evaluation. (See FIG. 3 (c).)

Next, when the master device 1 receives the report of the address information from the slave device 2-2 (FIG. 3: Arrow (4)), it confirms that a logical address that matches the logical address of “10001” that was reported by the slave device 2-2 is already stored in the memory, and compares the communication address “aaaa” that is stored in combination with that logical address “10001” with the reported communication address “aaab”.

In this case, the communication address “aaaa” that has been stored and the reported communication address “aaab” do not match, and so it is determined that the reported logical address “10001” is redundant. Additionally, the communication address “aaaa” that is stored in combination with the logical address “10001 is overwritten to the reported communication address of “aaab”, for use in the next redundancy evaluation. (See FIG. 3 (d).)

Next, let us assume that the error in the logical address of the slave device 2-2 has been discovered, and, part way through, the logical address of the slave device 2-2 is changed from “10001” to “10002”.

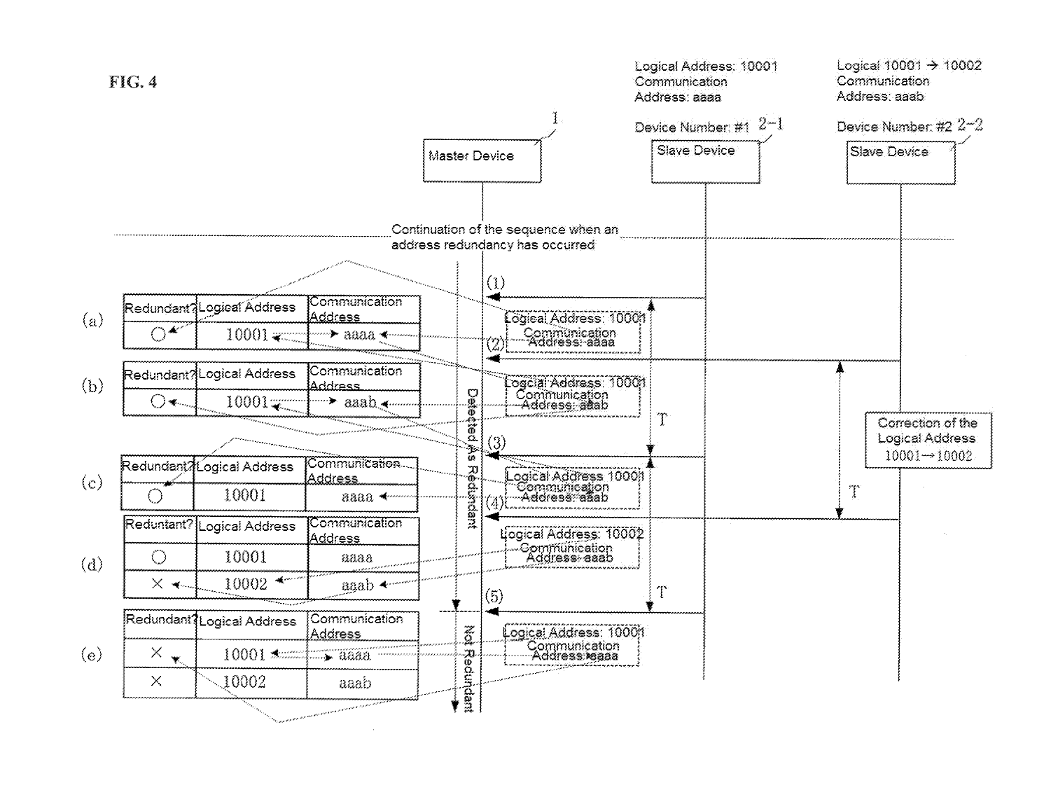

After the logical address of the slave device 2-2 has been changed from “10001” to “10002”, when the master device 1 receives the report of the address information from the slave device 2-1 (FIG. 4: Arrow (3)), it confirms that a logical address that matches the logical address of “10001” that was reported by the slave device 2-1 is already stored in the memory, and compares the communication address “aaab” that is stored in combination with that logical address “10001” with the reported communication address “aaaa”.

In this case, the communication address “aaab” that has been stored and the reported communication address “aaaa” do not match, and so it is determined that the reported logical address “10001” is redundant. Additionally, the communication address “aaab” that is stored in combination with the logical address “10001 is overwritten to the reported communication address of “aaaa”, for use in the next redundancy evaluation. (See FIG. 4 (c).)

Next, when the master device 1 receives the report of the address information from the slave device 2-2 (FIG. 4: Arrow (4)), no logical address that matches the logical address of “10002” that was reported by the slave device 2-2 is stored in the memory, so the combination of the purported logical address “10002” and the communication address “aaab” is stored into the memory. In this case, it is determined that no redundancy has occurred for the logical address “10002”. (See FIG. 4 (d).)

Next, when the master device 1 receives the report of the address information from the slave device 2-1 (FIG. 4: Arrow (5)), it confirms that a logical address that matches the logical address of “10001” that was reported by the slave device 2-1 is already stored in the memory, and compares the communication address “aaaa” that is stored in combination with that logical address “10001” with the reported communication address “aaaa”. In this case, the communication address “aaaa” that has been stored and the reported communication address “aaaa” match, and so it is determined that the redundancy for the logical address “10001” has been resolved.

### Function Block Diagram

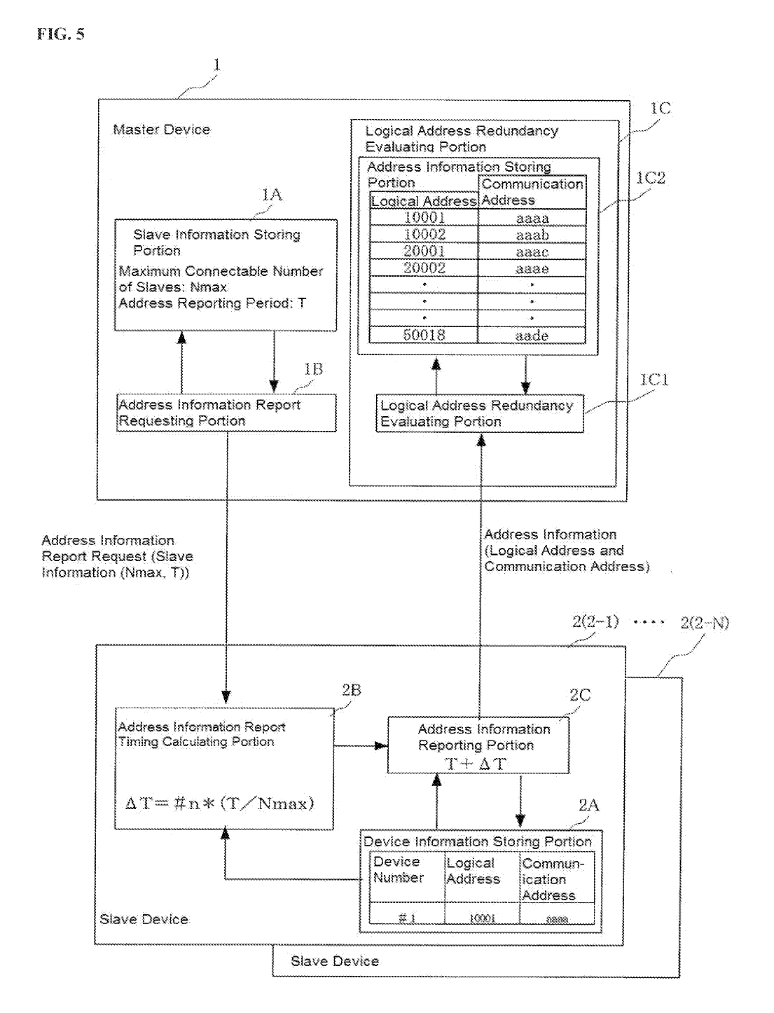

FIG. 5 shows a functional block diagram of the portions of a master device and a slave device in the radio communication system described above. The master device 1 and the slave device 2 are achieved through hardware including a processor and a storage device, and through a program to achieve the various types of functions in cooperation with this hardware.

The master device 1 has a slave information storing portion 1A for storing a maximum connectable number of slave devices Nmax and a reporting period for address information from the slave devices (an address reporting period) T; and address information report requesting portion 1B for broadcasting, to the slave devices 2-1 through 2-N, the slave information in the slave information storing portion 1A, after the power supply is turned ON (after initialization has been completed), and at long intervals (for example, once each hour), to request reporting of address information from the slave devices 2-1 through 2-N; and a logical address redundancy detecting portion 1C for detecting redundancies in the logical addresses set in the slave devices 2-1 through 2-N, based on the combinations of logical addresses and communication addresses that have been reported as address information from the slave devices 2-1 through 2-N in response to the address information reporting requests from the address information report requesting portion 1B.

Note that while in this example, the master device 1 requests reports of address information from the slave devices 2-1 through 2-N at long intervals, instead, the requests for reports of address information to the slave devices 2-1 through 2-N may be made only after the power supply has been turned ON, that is, only at the time of initialization of the master device 1.

The slave device 2 (2-1 through 2-N) includes a device information storing portion 2A for storing, as device information, a device number, a logical address, and a communication address; an address information report timing calculating portion 2B for receiving, from the master device 1, an address information reporting request and for calculating, as ΔT=#n*(T/N), the timing for reporting the local address information, from the maximum connectable number of slave devices Nmax, the reporting period T for the address information, and the device number #n; and an address information reporting portion 2C for reporting, to the master device 1, the local address information (the logical address and the communication address) with each address information reporting period T in accordance with the report timing ΔT calculated by the address information report timing calculating portion 2B.

In this master device 1, the logical address redundancy detecting portion 1C comprises a logical address redundancy evaluating portion 1C1 and an address information storing portion 1C2, where each time address information is received from the slave devices 2-1 through 2N, the combination of the logical address and the communication address is stored in the address information storing portion 1C2, and if, at the time of this storing, a logical address matching the received logical address has already been stored, the communication address that is stored in combination with that logical address is checked, where if that stored communication address and the received communication address do not match, it is determined that the received logical address is redundant. Moreover, if it is determined that the received logical address is redundant, then the communication address that is stored in combination with that logical address is overwritten with the received communication address.

The radio communication system according to the present example can be used in a variety of fields, such as midsized and large monitoring and control systems in mesh structures wherein the communication trunk lines are wireless. Specifically, one may consider application to air-conditioning systems within buildings that use VAV (variable air volume regulation).

1. A radio communication system comprising first through Nth (N≧2) slave devices and a master device for receiving messages from these slave devices, wherein:
the master device comprises:
a slave information storing device storing, as slave information, a maximum connectable number of slave devices and a reporting period for address information from slave devices;
an address information report requesting device broadcasting, at at least the time of startup, the slave information to the first through Nth slave devices to request reporting of address information from the first through Nth slave devices; and
a logical address redundancy detector detecting a redundancy in the logical addresses set in the first through Nth slave devices based on the logical addresses and communication addresses reported, as address information, from the first through Nth slave devices in response to the address information report request from the address information report requesting device; wherein
the first through Nth slave devices comprise:
a device information storing device storing, as device information, a device number that is determined sequentially with the maximum connectable number of slave devices as the maximum value, and a logical address and a communication address that are set as local address information;
an address information report timing calculator receiving the address information report request from the master device, and for calculating the timing for reporting the local address information based on the maximum connectable number of slave devices, which is received as slave information, the address information reporting period, and the device number that is stored as device information; and
an address information reporting device reporting, to the master device, local address information that is stored as device information, with each address information reporting period, in accordance with the report timing calculated by the address information report timing calculator.

2. The radio communication system as set forth in claim 1, wherein:
the logical address redundancy detector of the master device:
each time address information is received from the first through Nth slave devices, stores a combination of the logical address and the communication address that have been sent as address information, and if, at the time of this storing, a logical address matching the received logical address has already been stored, checks the communication address that is stored in combination with that logical address, and if that stored communication address and the received communication address do not match, determines that the received logical address is redundant.

3. The radio communication system as set forth in claim 2, wherein:
the logical address redundancy detector of the master device:
overwrites, with the received communication address, the communication address that is stored in combination with that logical address if it is determined that the received logical address is redundant.

4. A radio communication system as set forth in claim 2, wherein:
the logical address redundancy detector of the master device:
outputs the logical address to the outside if it is determined that the received logical address is redundant.
